(19) United States
(12) Patent Application Publication
(10) Pub. No.: US 2020/0379892 A1
(43) Pub. Date: Dec. 3, 2020

(54) AUTOMATED DETERMINATION OF OPERATING PARAMETER CONFIGURATIONS FOR APPLICATIONS

(71) Applicant: Lightbend, Inc., San Francisco, CA (US)

(72) Inventors: Omer Emre VELIPASAOGLU, Glashuetten-Sclossborn (DE); Alan Honkwan NGAI, Santa Clara, CA (US)

(73) Assignee: Lightbend, Inc., San Francisco, CA (US)

(21) Appl. No.: 16/891,015

(22) Filed: Jun. 2, 2020

Related U.S. Application Data
(60) Provisional application No. 62/856,674, filed on Jun. 3, 2019.

(51) Int. Cl. G06F 11/36; G06F 9/445

(52) U.S. Cl. CPC G06F 11/3688; G06F 9/44505; G06F 11/3692; G06F 11/3684

(57) ABSTRACT

The disclosed technology teaches configuring and reconfiguring an application running on a system, receiving a test configuration file with performance evaluation criteria and bounds for configuration dimensions defining a configuration hyperrectangle. The technology includes instantiating a reference instance and a test instance, subject to similar operating stressors and automatically testing alternative configurations within the configuration hyperrectangle, configuring and reconfiguring components of the test instance in the test cycles at configuration points within the configuration hyperrectangle, and applying a test stimulus to both instances for a dynamically determined cycle time. A test cycle time is dynamically determined by applying the performance evaluation criteria to determine a performance difference, evaluating stabilization of performance difference as the cycle progresses, dynamically determining the cycle to be complete when a stabilization criteria applied to the performance difference is met, advancing to a next configuration point until a test completion criteria is met, and reporting results.

### RELATED APPLICATION

This application claims priority under 35 U.S.C. § 119(e) to U.S. Provisional Application No. 62/856,674, entitled “AUTOMATED DETERMINATION OF OPERATING PARAMETER CONFIGURATIONS FOR APPLICATIONS”, filed 3 Jun. 2019 (Atty. Docket No.: LBND 1006-1), the entire contents of which are hereby incorporated by reference herein.

### FIELD OF THE TECHNOLOGY DISCLOSED

The technology disclosed relates generally to deploying and managing real-time streaming applications and in particular relates to automating determination of operating parameter configurations for applications.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Application deployment includes the determination of application configurations. Meanwhile, finding useful, effective values for configuration parameters is demanding. It is a laborious process that requires deploying the application many times to a production environment or a staging environment that closely resembles production. A typical application has dozens of parameters that can be optimized to gain efficiency in service levels and utilization of hardware. Furthermore, the relationship of these parameters to key performance indicators is usually nonlinear. It is exceedingly difficult for human operators to visualize this nonlinear objective in high dimensional space to guess what parameter combinations could yield improvement over the existing ones. Even when testing of incremental guesses for determining configuration parameter values is feasible, test iterations for the parameters can take on the order of hours, and the complete configuration exercise can take days, with unbroken attention not typically readily available.

An opportunity arises for configuring and reconfiguring an application running on a system and automatically testing alternative configurations within a configuration hyperrectangle.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The color drawings also may be available in PAIR via the Supplemental Content tab.

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings.

FIG. 1 illustrates an architectural level schematic of an application configuration system.

FIG. 2 shows a block diagram for configuring and reconfiguring an application running on a system according to one implementation of the disclosed technology.

FIG. 3 shows an example configuration map via which an operations engineer specifies which parameters need to be configured.

FIG. 4 lists drone tracker app pipeline configuration parameters along with step size, type, minimum and maximum performance evaluation criteria for the parameters listed.

FIG. 5A and FIG. 5B list framework configuration parameters for the drone tracker example, with step size, minimum and maximum performance evaluation criteria for each parameter listed.

FIG. 6 shows an example enumerated list of config parameters with initial baseline values for the drone tracker app.

FIG. 7A shows a visual summary of results with dynamically determined multiple local minima for applied test stimuli with multiple different starting configurations, according to one implementation of the disclosed technology.

FIG. 7B shows a graph of a hypothetical objective surface, with extreme points that represent parameter combinations for which an application can become unresponsive.

FIG. 8 shows an example, for an app, of evaluating stabilization of the performance difference as a particular test cycle progresses, with a linear time invariant (LTI) single pole filter curve fit to the objective value observations.

FIG. 9 shows an example console for a container orchestration system for automating application deployment, scaling, and management of instances of the drone tracker application.

FIG. 10 shows performance metrics and parameter states that can be collected for the drone tracker application via the monitoring system, with control output for app parameters being configured.

FIG. 11 shows drone tracker example control output for framework parameters being configured.

FIG. 12 displays an overall objective function, for the drone tracker example, that summarizes the end to end overall latency, as a function of time when the eleven parameters are tuned together.

FIG. 13 shows an example of the median commit latency in milliseconds for an app that utilizes reconfiguration without restarting.

FIG. 14 is a simplified block diagram of a computer system that can be used for configuring and reconfiguring an application running on a system, according to one implementation of the disclosed technology.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

Modern application deployment tools provide a framework in which application parameter configuration can be tuned. Many configuration parameters are application specific and tool specific. For example, the Akka open-source toolkit and runtime for simplifying the construction of concurrent and distributed applications on the Java virtual machine (JVM), has dozens of configuration parameters. Selecting effective values for a myriad of configuration parameters can be laborious and time consuming, and requires staging, as the combinatorial effects of changes to multiple configuration parameters for an app are typically nonlinear. Business implications include the engineering cost for load testing and fine tuning configurations for applications, and the effects can include sub-optimal resource utilization due to sub-optimal configuration.

Black box testing is usable to check that the output of an application is as expected, given specific configuration parameter inputs. In most black box problems, the objective function can be evaluated but the gradient is not available or estimating it is expensive. In such cases, gradient-free methods such as Nelder-Mead method can be used, with the limitation that the heuristic search method can converge to non-stationary points.

In complex problems that consider the compound effects of many configuration parameters being modified, the black box approach is usable to address the complexity. Unique challenges exist for determining values for a set of configuration parameters for an application as related to handling the stochastic nature of the objective function due to serving live traffic and dealing with boundary conditions due to restarts of the application. The disclosed technology offers methods for addressing the challenges described. Example system architecture for configuring and reconfiguring an application running on a system is described next.

### Architecture

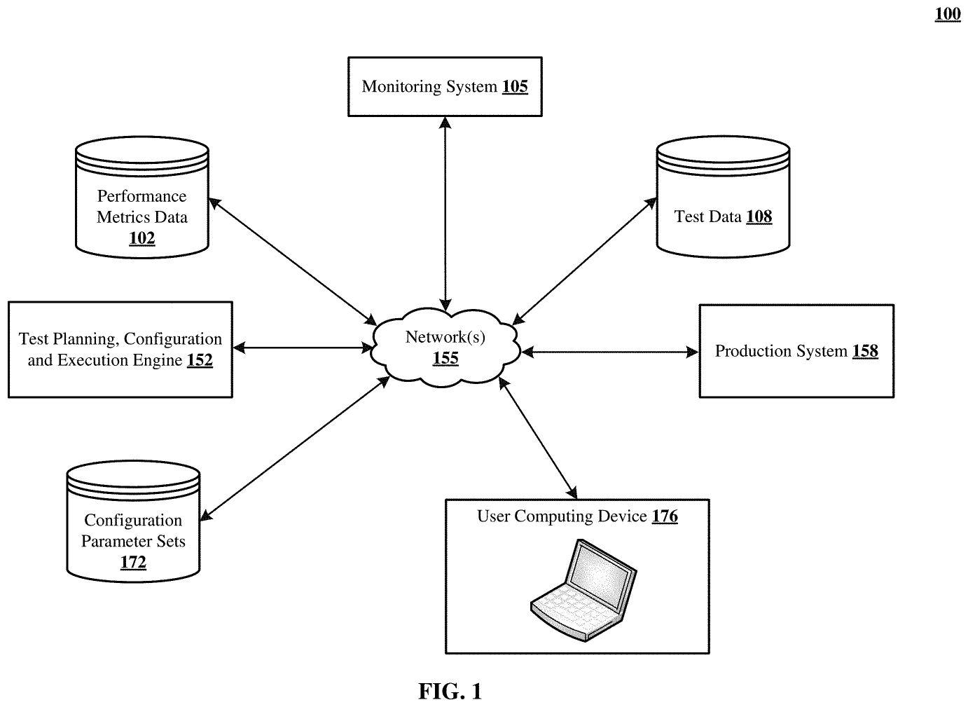

FIG. 1 illustrates an architectural level schematic of system 100 for configuring and reconfiguring applications and reporting configuration settings that meet test configuration criteria. Because FIG. 1 is an architectural diagram, certain details are intentionally omitted to improve clarity of the description. The discussion of FIG. 1 will be organized as follows. First, the elements of the figure will be described, followed by their interconnections. Then, the use of the elements in the system will be described in greater detail. FIG. 1 includes test planning, configuration and execution engine 152, performance metrics data 102, monitoring system 105, test data 108, network(s) 155, production system 158, configuration parameter sets 172 and user computing device 176. In other implementations, system 100 may not have the same elements or components as those listed above and/or may have other/different elements or components instead of, or in addition to, those listed above. The different elements or components can be combined into single software modules and multiple software modules can run on the same hardware.

At the center of system 100 is disclosed test planning, configuration and execution engine 152 for automatically testing alternative configurations within the configuration hyperrectangle in applications in production system 158. Production system 158 runs at least one reference instance of the application and at least one test instance of the application at the same time, with the reference instance and the test instance subject to similar operating stressors during test cycles, to control for external factors. Some applications utilize hot reconfiguration, to access configured or reconfigured configuration parameters, without the need to restart the app, such as applications that include carts for accepting user choices. For other applications, reconfiguration of the configuration parameters takes place when the application is restarted, such as a drone or other application that dynamically controls for hardware.

Configuration parameter sets 172 include sets of configuration dimensions, with each set defining a configuration hyperrectangle that represents the n-dimensional set of configuration parameters for an app. Test planning, configuration and execution engine 152 automatically tests alternative app configurations within the configuration hyperrectangle and monitoring system 105 collects and stores performance metrics data 102. Test planning, configuration and execution engine 152 utilizes test data 108 that includes test instance results as well as configuration parameter sets 172 in the consideration of performance differences and determinations of next sets for reconfiguring and testing an application. The disclosed test planning, configuration and execution engine 152 utilizes analytics platform tools for querying, visualizing and alerting on performance metrics data 102, which includes results of automatic testing in which a test stimulus is applied for an application, and results are stored for both reference instances and test instances. User computing device 176 accepts operator inputs, which include starting values for configuration parameter components, and displays reporting results of the automatic testing, including configuration settings from one of the configuration points.

In the interconnection of the elements of system 100, network 155 couples test planning, configuration and execution engine 152, production system 158, monitoring system 105, performance metrics 102, test data 108, configuration parameter sets 172 and user computing device 176 in communication. The communication path can be point-to-point over public and/or private networks. Communication can occur over a variety of networks, e.g. private networks, VPN, MPLS circuit, or Internet. Network(s) 155 is any network or combination of networks of devices that communicate with one another. For example, network(s) 155 can be any one or any combination of a LAN (local area network), WAN (wide area network), telephone network (Public Switched Telephone Network (PSTN), Session Initiation Protocol (SIP), 3G, 4G LTE), wireless network, point-to-point network, star network, token ring network, hub network, WiMAX, WiFi, peer-to-peer connections like Bluetooth, Near Field Communication (NFC), Z-Wave, ZigBee, or other appropriate configuration of data networks, including the Internet. In other implementations, other networks can be used such as an intranet, an extranet, a virtual private network (VPN), a non-TCP/IP based network, any LAN or WAN or the like.

Performance metrics data 102, test data 108 and configuration parameter sets 172 can store information from one or more tenants and one or more applications into tables of a common database image to form an on-demand database service (ODDS), which can be implemented in many ways, such as a multi-tenant database system (MTDS). A database image can include one or more database objects. In other implementations, the databases can be relational database management systems (RDBMSs), object oriented database management systems (OODBMSs), distributed file systems (DFS), no-schema database, or any other data storing systems or computing devices. In some implementations, the gathered metadata is processed and/or normalized. In some instances, metadata includes structured data and functionality targets specific data constructs. Non-structured data, such as free text, can also be provided by, and targeted to production system 158. Both structured and non-structured data are capable of being aggregated. For instance, assembled metadata can be stored in a semi-structured data format like a JSON (JavaScript Option Notation), BSON (Binary JSON), XML, Protobuf, Avro or Thrift object, which consists of string fields (or columns) and corresponding values of potentially different types like numbers, strings, arrays, objects, etc. JSON objects can be nested and the fields can be multi-valued, e.g., arrays, nested arrays, etc., in other implementations.

In some implementations, user computing device 176 can be a personal computer, laptop computer, tablet computer, smartphone, personal digital assistant (PDA), digital image capture devices, and the like, and can utilize an app that can take one of a number of forms, including user interfaces, dashboard interfaces, engagement consoles, and other interfaces, such as mobile interfaces, tablet interfaces, summary interfaces, or wearable interfaces. In some implementations, the app can be hosted on a web-based or cloud-based privacy management application running on a computing device such as a personal computer, laptop computer, mobile device, and/or any other hand-held computing device. It can also be hosted on a non-social local application running in an on premise environment. In one implementation, the app can be accessed from a browser running on a computing device. The browser can be Chrome, Internet Explorer, Firefox, Safari, and the like. In other implementations, the app can run as an engagement console on a computer desktop application.

While system 100 is described herein with reference to particular blocks, it is to be understood that the blocks are defined for convenience of description and are not intended to require a particular physical arrangement of component parts. Further, the blocks need not correspond to physically distinct components. To the extent that physically distinct components are used, connections between components can be wired and/or wireless as desired. The different elements or components can be combined into single software modules and multiple software modules can run on the same hardware.

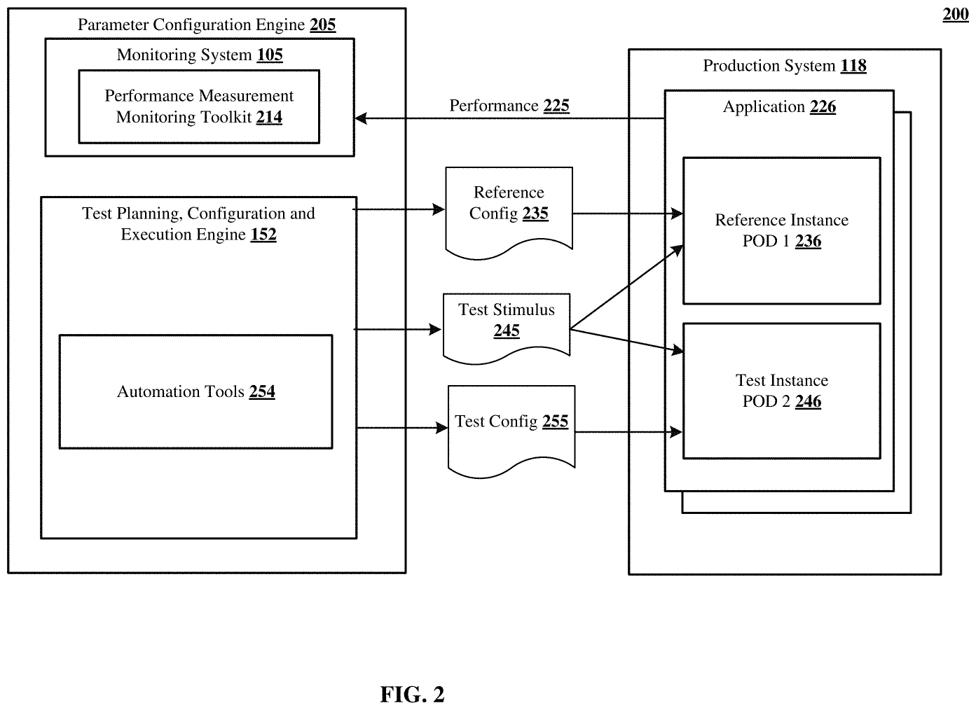

FIG. 2 shows a block diagram 200 for configuring and reconfiguring an application running on a system. Parameter configuration engine 205 includes test planning, configuration and execution engine 152 and monitoring system 105. Block diagram 200 also includes production system 118 with application 226. In one implementation, a staging environment that closely resembles production system 118 can be utilized in lieu of production system 118. Parameter configuring and reconfiguring can occur for multiple different applications in parallel. As an overview summary, parameter configuration engine 205 utilizes test planning, configuration and execution engine 152 to plan the test and manipulate the configuration parameters for reference config 235, test stimulus 245 and test config 255. Application 226 in production system 118 runs reference instance POD 1 236 and test instance POD 2 246 in parallel. Test planning, configuration and execution engine 152 applies baseline configuration parameters to the reference instance in reference config 235, planned test configuration parameters to the test instance in test config 255, and test stimulus 245 to both the reference instance and the test instance of the application. The reference instance of the app provides a baseline for accounting for production system changes over time. Monitoring system 105 monitors and reports the results of the automatic testing. Test planning, configuration and execution engine 152 decides timing for advancing to a next configuration point within the configuration hyperrectangle until a test completion criteria is met.

Monitoring system 105 includes performance measurement monitoring toolkit 214. In one implementation, open-source systems monitoring and alerting toolkit Prometheus utilizes a multi-dimensional data model with time series data identified by metric name and key/value pairs, using a flexible query language to leverage this dimensionality. Performance measurement monitoring toolkit 214 can utilize a pull model over HTTP for time series collection, with targets discovered via service discovery or static configuration. Performance measurement monitoring toolkit 214 also supports graphing and dashboards for reporting results of the automatic testing. In another implementation, a different monitoring and alerting toolkit can be used for measurements and analytics.

Continuing with the description of FIG. 2, test planning, configuration and execution engine 152 utilizes automation tools 254 that collect the performance metrics and configuration parameter states from monitoring system 105. Test planning, configuration and execution engine 152 performs analysis to decide the next set of configuration parameter values to use in tests to determine a performance difference. The next set of configuration parameters is then sent in config map 255 to application 226 by an actuator, to change the state of the test instance of the application. In one example, application 226 is implemented using Kubernetes as the distributed system for assigning unique IP addresses and for scheduling to ensure enough available containers in pods, and the config map is updated via the Kubernetes API. Kubernetes is a container orchestration system for automating deployment, scaling and management. Test planning, configuration and execution engine 152 leverages Kubernetes' ConfigMap functionality to represent a set of application control parameters as metadata and to the application as a test config 255. The application can utilize hot reconfiguring of that configuration file on change by monitoring for file changes and then re-reading the file. Alternatively, a control mechanism can delete a pod after control update and Kubernetes will automatically restart the pod, which will restart the application, which will load the new changed config file. The disclosed technology leverages a mechanism that Kubernetes provides to manage relatively static metadata as a dynamic control mechanism for applications. Configuration parameter sets 172 utilize etcd in one example; and in a different implementation a configuration store such as Apache ZooKeeper can be utilized.

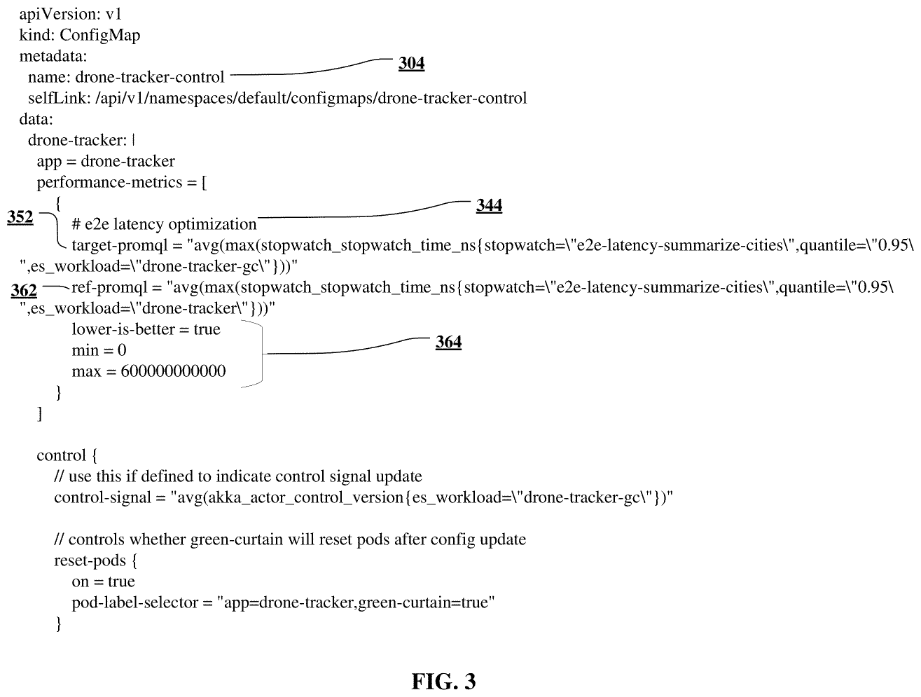

FIG. 3 through FIG. 6 list an example test configuration file that includes performance evaluation criteria and upper and lower bounds of settings for configuration dimensions defining a configuration hyperrectangle. FIG. 3 shows an example configuration for a drone tracker application 304 via which an operations engineer specifies which parameters need to be configured. In this example, end to end latency 344 is specified as performance evaluation criteria in which a lower value is better, and with a zero minimum and a 600,000,000,000 maximum 364. In this implementation the configuration map is displayed in YAML, a human readable data serialization language. Configuration can be specified using a different language, such as JSON, in another implementation.

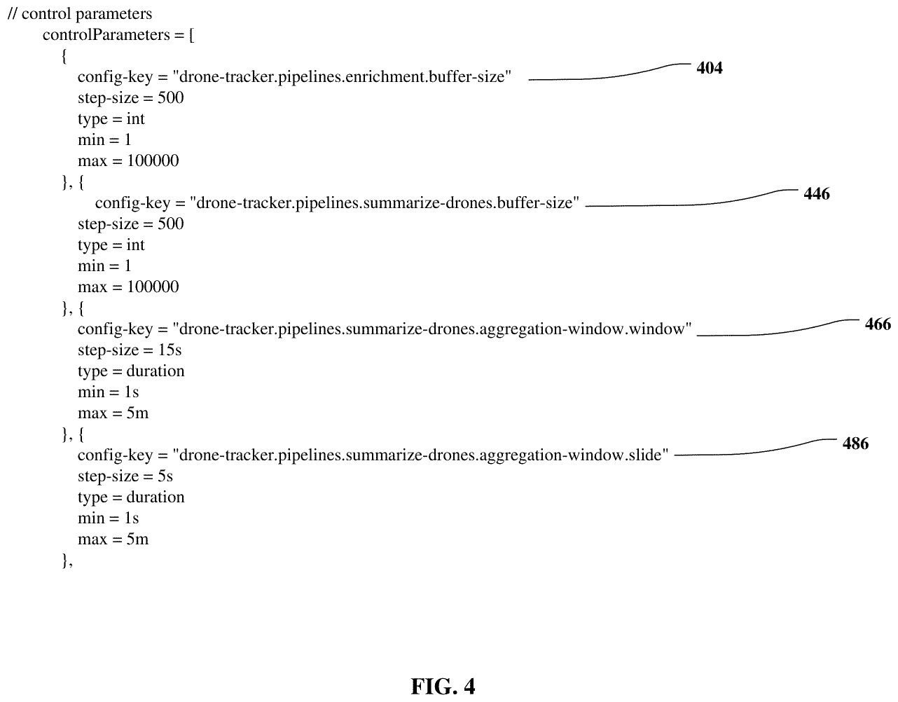

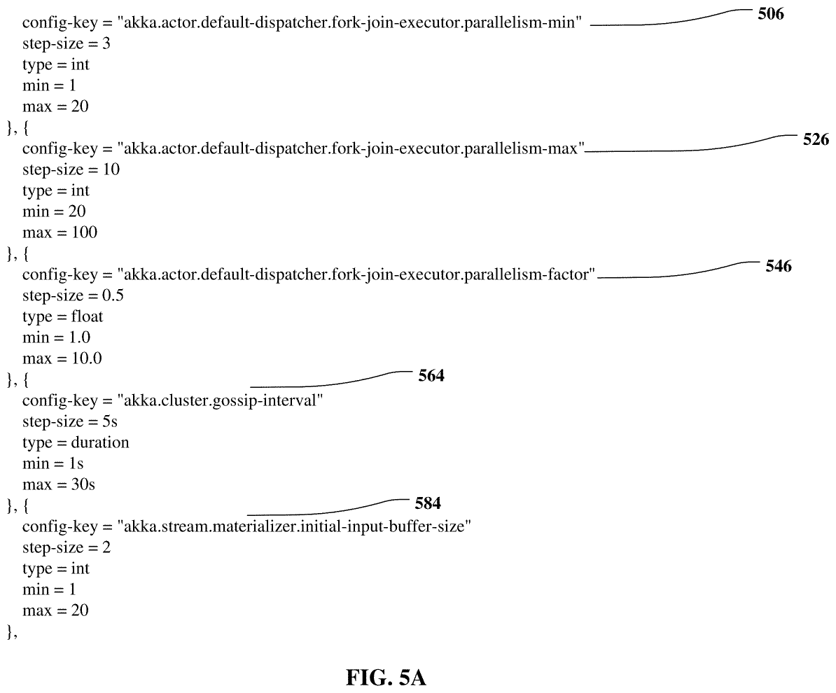

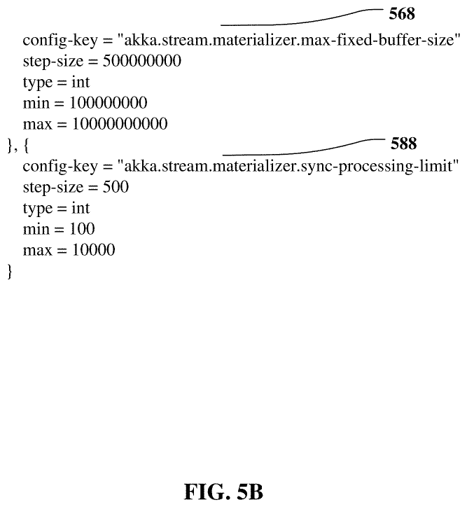

Continuing with the description of the test configuration file for the drone tracker application, FIG. 4, FIG. 5A and FIG. 5B show eleven configuration parameters that need to be configured together. Drone tracker application is a streaming data processing application leveraging a pipeline. It has a data enrichment stage in which the data received from the drones is joined with other data, and a summarization stage in which the data is aggregated into windows based on timestamps and summarized. The application parameters include configuration parameters for affecting the behavior of these stages. FIG. 4 lists drone tracker pipeline configuration parameters: drone-tracker.pipelines.enrichment.buffer-size 404—the pipeline (queue) buffer size for data enrichment stage; drone-tracker.pipelines.summarize-drones.buffer-size 446—the pipeline (queue) buffer size for drone summarization stage; drone-tracker.pipelines.summarize-drones.aggregation-window.window 466—the aggregation window size for drone summarization stage; and drone-tracker. pipelines, summarize-drones, aggregation-window, slide 486—the amount to slide the aggregation window for drone summarization stage. FIG. 4 also lists step size, type, minimum and maximum performance evaluation criteria that identify feasible regions for the four control parameters listed.

FIG. 5A and FIG. 5B list seven framework configuration parameters to be configured for the drone tracker app, along with step size, and minimum and maximum performance evaluation criteria for each parameter listed. Drone tracker application uses the Akka framework, an actor model based distributed programming framework that leverages a dispatcher to route the messages. Fork-join-executor is the default dispatcher. Parallelism parameters to be configured include akka.actor.default-dispatcher.fork-join-executor.parallelism-min 506—the minimum number of threads to cap factor-based parallelism number to; akka.actor.default-dispatcher.fork join-executor. parallelism-max 526—the maximum number of threads to cap factor-based parallelism number to; and akka.actor.default-dispatcher.fork-join-executor.parallelism-factor 546—the level of parallelism (threads) ceil (available processors*factor). Akka cluster provides a fault-tolerant decentralized peer-to-peer based cluster membership service with no single point of failure or single point of bottleneck. It does this using gossip protocols and an automatic failure detector, in which the current state of the cluster is gossiped randomly through the cluster, with preference to members that have not seen the latest version. Periodically, each node chooses another random node to initiate a round of gossip with. An additional framework parameter to be configured is akka.cluster.gossip-interval 564—the length of interval for gossip. Also, Akka Streams uses buffers to manage difference in upstream and downstream rates, especially when the throughput has spikes, so the parameter akka.stream.materializer.initial-input-buffer-size 568—the initial size of the buffer used in stream elements, needs to be configured, along with akka.stream.materializer.max-fixed-buffer-size 584—the maximum size of the buffer for stream elements that have explicit buffers, and akka.stream.materializer.sync-processing-limit 588—a maximum number of sync messages that actor can process for stream to substream communication. This parameter allows the interruption of synchronous processing to get upstream/downstream messages, and allows acceleration of message processing that is happening within same actor but keeps system responsive. For the example of configuring and reconfiguring drone tracker parameters, these seven framework parameters are configured dynamically with the four app parameters described relative to FIG. 4. That is, eleven configuration dimensions define the configuration hyperrectangle for the drone tracker example, for automatically testing alternative configurations within the configuration hyperrectangle.

A test configuration file call to an app configuration map for the drone tracker application is listed next.

app-config-map {

name = “drone-tracker-gc-control”
data-key = “control.conf”
control-version-field-key = “drone-tracker.green-curtain.control-version”

}

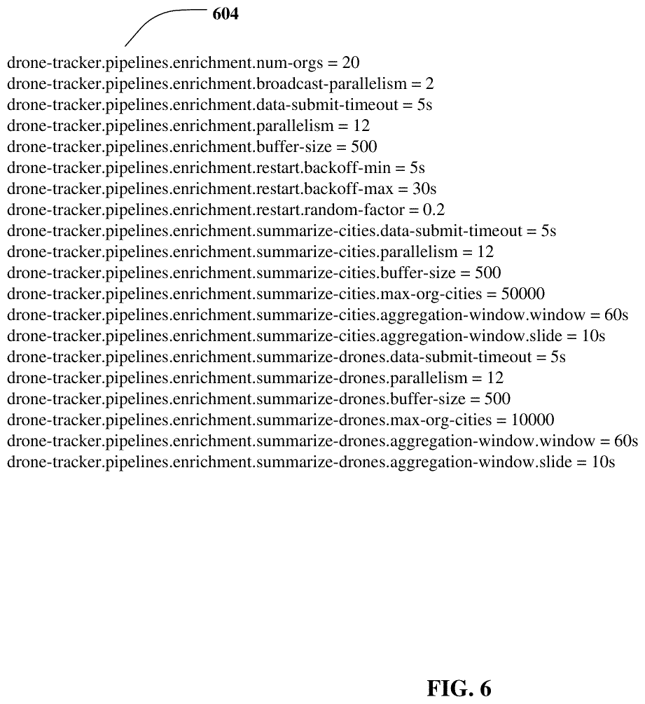

FIG. 6 shows an example enumerated list of config parameters with initial baseline values 604 for the drone tracker app, usable by test planning, configuration and execution engine 152.

Automatic configuration of multiple parameters for an app is iterative in its nature. In many cases, the target application can be stopped and restarted with a new set of configuration parameters, for each iteration. In such cases, an iteration involves setting the configuration parameters to the new desired values, restarting the application, and measuring the target performance metrics, thus obtaining the value of the objective function to be optimized at the current configuration settings.

In most cases, the objective function is not available analytically for configuration of multiple parameters for an app, hence the derivatives are also not available. While the value of the objective function can be obtained, the stopping and restarting process is nontrivial and it takes time to reach the point at which the objective function can be observed at the current configuration settings. Therefore, estimating the derivatives via measuring the objective function value at different points in the configuration parameter space is costly. This makes methods such as the Nelder-Mead simplex method appealing.

Due to the complexity of applications, performance metrics of interest possess random fluctuations. On the other hand, methods like Nelder-Mead assume deterministic objective functions. In order to deal with the noise in the objective function, various improvements to the solution method such as estimation of the initial step size, smoothing of the observations and restarting the search are needed.

For the iterative descent methods that reduce the step size gradually, it is important to choose the initial step size correctly. If the initial step size is too small, the noise in the performance metric can mimic local minima, causing the search to terminate prematurely. One way to deal with this problem is to estimate the temporal standard deviation at a small set of random points and choose the initial step size, or the initial simplex size in the case of the Nelder-Mead method, at least equal to that or a small multiple of it.

Deterministic methods for determining configuration parameters that meet test criteria need to deal with the noise in the objective function beyond the initial step. The noise can be tolerated better when the descent is steep. Therefore an adaptive smoothing strategy needs to be employed where the size of the temporal sampling window for smoothing (i.e. obtaining a mean objective value) is increased when the improvement of the target performance metric slows. Alternatively, the temporal sampling window size can be decreased if the improvement of the target performance metric increases.

Nelder-Mead can be inefficient when the dimension of the search space (i.e. the number of configuration parameters to be determined) is large. This manifests itself as the search focusing on a subset of the dimensions. The restart frequency should therefore be proportional to the ratio of the search space size and size of the subset of focus.

It is possible to deal with the stochastic nature of the objective function by leveraging probabilistic methods. Bayesian methods are very suitable for this purpose since they are also the choice for cases in which evaluation of the objective function is expensive and there is a limited budget for the number of objective function evaluations.

Automatic optimization of application configurations almost certainly involves a mixture of continuous, integer and categorical parameters. While most Bayesian optimization versions are designed for continuous variables, there are some versions capable of dealing with mixed variables. Albeit, this capability comes with a loss of efficiency, and convergence requires more iterations and objective function evaluations than pure continuous variable cases. Therefore, using the fitting exploration method and the exploration-exploitation trade-off and schedule becomes important.

Test planning, configuration and execution engine 152 allows the user to specify a delay, window length 636, period and an aggregation method for sampling the objective value. Delay specifies an additional sleep period before sampling begins. Once under way, the objective values are measured every period of seconds for a total window length of samples. The final value reported to the next step is the aggregated value, as a mean or median. Deterministic methods such as Nelder-Mead utilize the smoothing step, but smoothing is not as vital for stochastic methods such as Bayesian Optimization.

Test planning, configuration and execution engine 152 manages the automated control cycle which includes automatically testing alternative configurations within the configuration hyperrectangle, including configuring and reconfiguring one or more components of the test instance 246 of application 226 in the test cycles at configuration points within the configuration hyperrectangle. Monitoring system 105 reads the steady state measurement of performance 225 for analysis iterations. Test planning, configuration and execution engine 152 runs analysis for determining what next test stimulus to apply to the test instance of the application at the configuration points for a dynamically determined test cycle time, and repeats this set of actions to meet the performance metric specified while using as few iterations as possible. The performance metric forms a nonlinear surface that is a function of the controlled parameters, due to combinatorial effects of changes to multiple configuration parameters. Said differently, computers can change four independent operating parameters simultaneously even though people cannot. It is often unclear how a knob turn will impact performance. When a dozen parameters need to be configured, changes in the values of three parameters may significantly impact results, for instance.

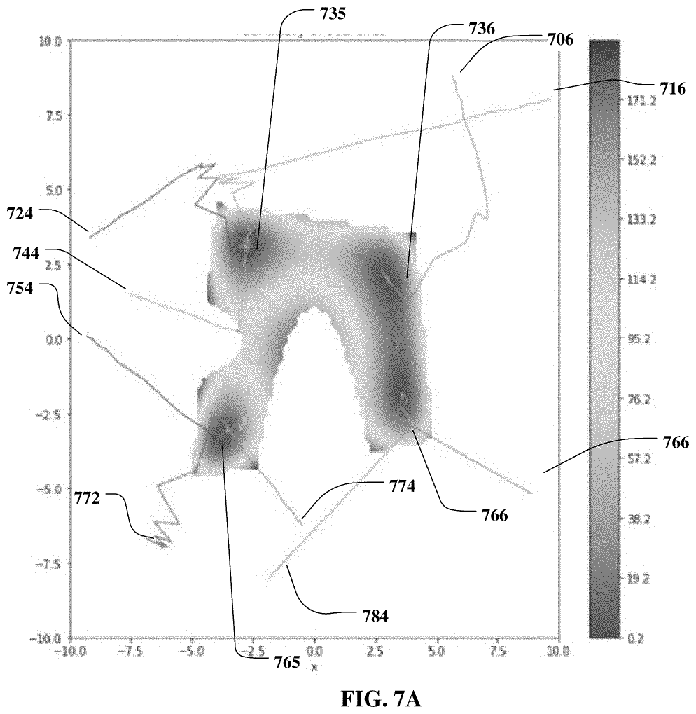

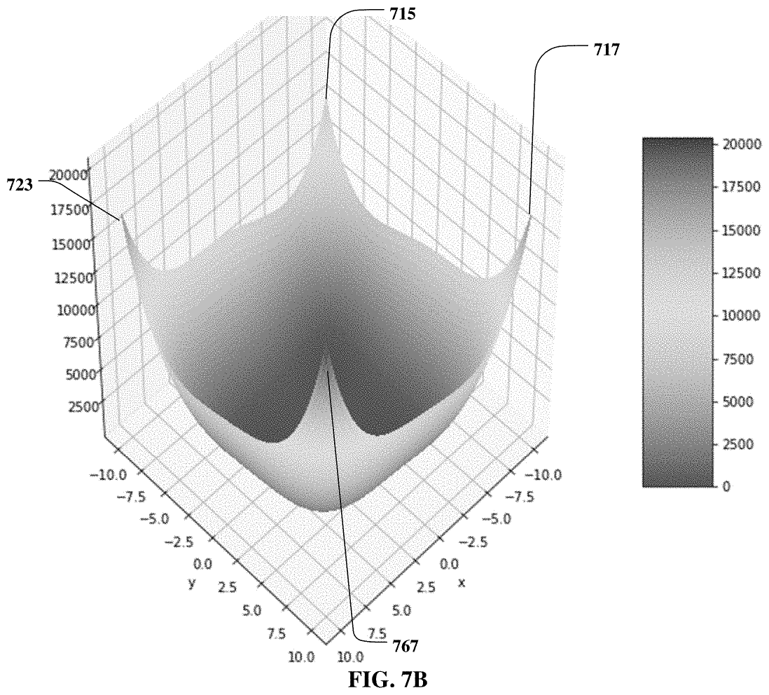

FIG. 7A shows a visual summary of results with dynamically determined multiple local minima 735, 736, 765, 766 for applied test stimuli with multiple different starting configurations 706, 716, 724, 744, 754, 766, 772, 774, 784. Using a Nelder-Mead simplex strategy, each test cycle is a descent from the initial test configuration applied to the test instance of the application at the configuration points to a minimum of the performance metric. In one implementation, the test cycle would run several times, and the best result would be selected. Analysis of the result of a most recent control step is usable for determining the next configuration set. Nelder-Mead updates the simplex and queries the vertices, with a cache for the objective values observed previously, so a single new query for the new simplex for the vertex that has changed.

Using a Bayesian strategy as an alternative, each test cycle is a sequence of regression fits. Test planning, configuration and execution engine 152 fits a new regression surface, using a Gaussian process or other regression method such as gradient boosted regression trees, for each test stimulus iteration, and determines a new test candidate point based on uncertainty of an existing fit, with an acquisition function computed to yield the next query. Bayesian optimization is described in detail in “Taking the Human Out of the Loop: A Review of Bayesian Optimization” by Bobak Shahriari, Kevin Swersky, Ziyu Wang, Ryan P. Adams and Nando de Freitas.

An application can be unresponsive for some parameter combinations, due to loose bounds defined for the parameters being configured. If the application becomes unresponsive, the objective value cannot be measured. FIG. 7B shows a graph of a hypothetical objective surface, with extreme points 715, 717, 723, 767 that represent example parameter combinations for which an application can become unresponsive. In some cases, this results in canceling a current test cycle when the current settings from a current configuration point prove infeasible, as determined by unresponsiveness of a component of the test instance or a time out. Test planning, configuration and execution engine 152 can utilize a back off solution in which the application is reconfigured back to a known responsive state, to address unresponsiveness, but a proxy value is used as the objective value instead of one measured from the application. In this use, a proxy value, which can be determined dynamically in some implementations, allows the search process to continue in the absence of a measured objective value.

To find a good proxy value, test planning, configuration and execution engine 152 can do an initial search before the testing begins. For a minimization problem, to find a large enough objective value that can serve as a proxy for cases in which the application becomes unresponsive, test planning, configuration and execution engine 152 can use a simple ascent method such as a coordinate ascent that successively minimizes along coordinate directions to find the minimum of the function, combined with a line search method, by taking small steps to the left and right of the current point—using the step size provided by the operator, in some cases.

Once an estimate of the large value is obtained, the Bayesian fitting process can proceed. If during the iterations, a measured objective value larger than the proxy is encountered, the proxy value can be updated dynamically. For Bayesian fitting, the iterations for which the application became unresponsive and the reconfiguration test is backed off of, the proxy value used is updated with the new proxy value, and the regression gets updated over the set of observations. That is, test planning, configuration and execution engine 152 dynamically updates proxy evaluation values for configuration points, within the configuration hyperrectangle, to which it was infeasible to apply the performance evaluation criteria, as determined by unresponsiveness of a component of the test instance or a time out. For Nelder-Mead, the descent can continue and use the new large proxy value where needed.

To speed up the Bayesian fitting process, test planning, configuration and execution engine 152 can modify the acquisition method, receiving multiple candidate parameter sets from the acquisition function along with their acquisition value—that is, the criterion used by the acquisition function to select the next query point. Test planning, configuration and execution engine 152 calculates a modified acquisition value by dividing the original acquisition value with a penalty that is proportional to the reciprocal of the distance of the query point to the closest known infeasible point, thereby reducing the acquisition value of the query candidates that are close to known infeasible points.

In some cases, stopping and starting an app to change configuration parameters is not feasible, and the configuration changes need to be applied to live applications. While this may be possible, it introduces a potential problem of lingering effects of old configuration parameter values.

One way to deal with the transient effects of configuration change in a live system is to treat the performance metric under study as an output of a system that experiences a step function change in its input. Hence the simplest, yet an effective method is to model the objective function as the output of a linear time-invariant (LTI) system under step change. This can be achieved by fitting a single pole low pass filter to the performance metric from the moment when the configuration is applied. After a high quality fit is achieved and the smoothed objective function has saturated, it can be sampled to record the objective function value for the iteration. A particular test cycle time can be dynamically determined by applying the performance evaluation criteria to the reference instance and to the test instance to determine a performance difference.

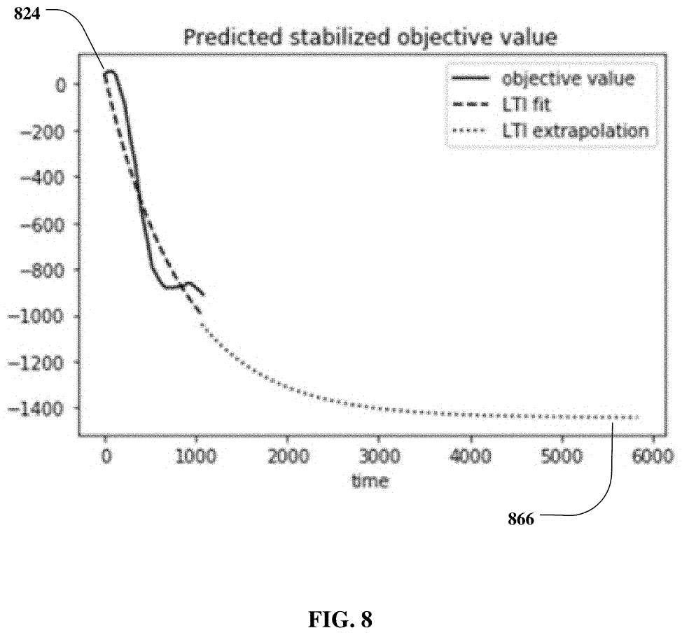

FIG. 8 shows an example, for an app that does not need to be restarted to update config parameters, of evaluating stabilization of the performance difference as a particular test cycle progresses, with objective values 824 as a solid line for the first 1200 milliseconds (ms) of the test cycle. The stabilization criteria includes fitting a single pole filter curve to the performance difference as the particular test cycle progresses and evaluating a slope of the single pole filter curve to determine the test cycle time at which the performance difference has stabilized, dynamically determining the particular test cycle to be complete when a stabilization criteria applied to the performance difference is met. FIG. 8 shows a linear time invariant (LTI) single pole filter curve 866 fit to the objective value observations, with an LTI extrapolation to 6000 ms. For this example, the objective value has stabilized by 5000 ms.

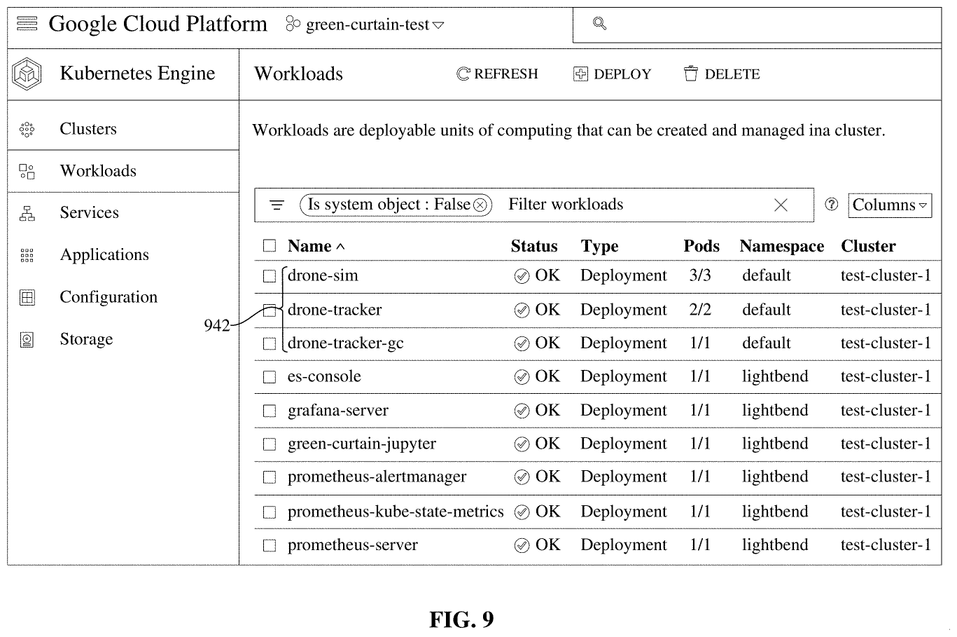

FIG. 9 shows an example console for a container orchestration system for automating application deployment, scaling, and management of instances of the drone tracker application 942 with drone-tracker as a reference instance, drone-tracker-GC as a test instance and drone-sim as the test data. In the example, the system is an open source Kubernetes engine. An operator framework can be utilized to extend the Kubernetes API using custom resource content to perform the configuring and reconfiguring of the components. In another implementation, a different system can include an open-source distributed general-purpose cluster-computing framework, such as Apache Spark, with implicit data parallelism and fault tolerance. One implementation can utilize a Spark streaming application tuning client that leverages an operator, such as the Spark Operator.

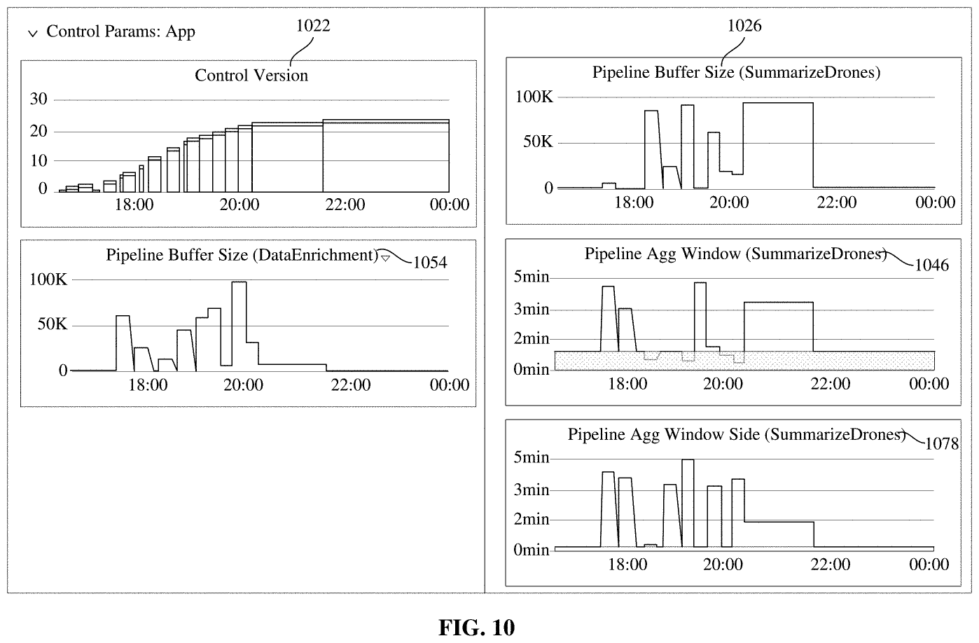

FIG. 10 shows performance metrics and parameter states that can be collected for the drone tracker application via the monitoring system, with control output for app parameters being configured. Control version 1022 displays a reference instance response over time. Bars in this figure represent restarts for updated configuration parameter iterations. The app reports a configuration ID, also referred to as the iteration number, through a metric collected by performance measurement monitoring toolkit 214, and test planning, configuration and execution engine 152 reads and updates the iteration number. Test planning, configuration and execution engine 152 queries performance measurement monitoring toolkit 214 for the objective value reported by the test instance as target-promql 352 and the reference instance as ref-promql 362, as listed in the configuration example of FIG. 3. Some apps, after receiving the new configuration and reporting updated configuration ID, stop reporting metrics for an unspecified duration. The duration required for an application to start reporting metrics after configuration update can vary and is reflected in the different widths of the bars.

Continuing the description of FIG. 10, pipeline buffer size (data enrichment) 1052 displays the values for drone tracker pipeline configuration parameter drone-tracker.pipelines.enrichment.buffer-size 404, the pipeline buffer size for data enrichment stage. The minimum value of one and the maximum value of 100K are reflected in the output graph. Pipeline buffer size (summarize drones) 1026 displays the values for the drone-tracker.pipelines.summarize-drones.buffer-size 446 parameter. Pipeline agg window (summarize drones) 1046 displays the values for the drone-tracker.pipelines.summarize-drones.aggregation-window.window 466 in a range of zero to five minutes. Pipeline agg window slide (summarize drones) 1078 displays the values for drone-tracker. pipelines, summarize-drones, aggregation-window. slide 486—the amount to slide the aggregation window with for drone summarization stage. FIG. 4 also lists step size, type, minimum and maximum performance evaluation criteria for the four parameters listed.

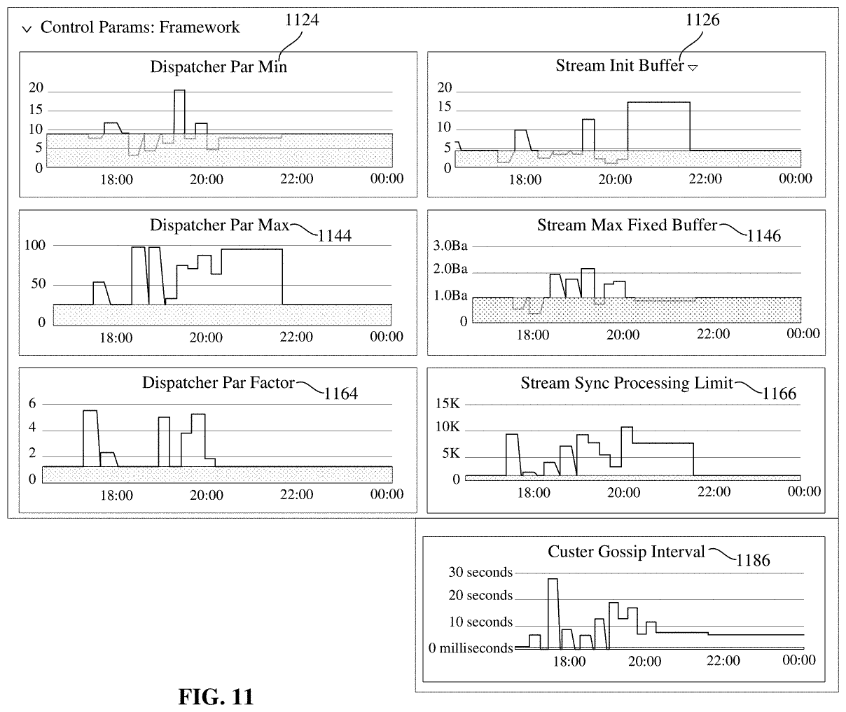

FIG. 11 shows drone tracker example control output for framework parameters being configured. Dispatcher par min 1124 displays the values for akka.actor.default-dispatcher.fork-join-executor.parallelism-min 506—the minimum number of threads to cap factor-based parallelism number to, with min set to one and max set to twenty. Dispatcher par max 1144 displays the values for akka.actor.default-dispatcher.fork join-executor. parallelism-max 526, the maximum number of threads to cap factor-based parallelism number to, with a minimum of 20 and a maximum of 100. Dispatcher par factor 1164 displays the values for config parameter akka.actor.default-dispatcher.fork join-executor. parallelism-factor 546. Cluster gossip interval 1186 displays the values for framework parameter akka.cluster.gossip-interval 564, the length of interval for gossip, which is specified with a minimum range of one second and maximum range of 30 seconds. Akka streams uses buffers to manage difference in upstream and downstream rates, especially when the throughput has spikes. Stream init buffer 1126 displays the values for parameter akka.stream.materializer.initial-input-buffer-size 568. Stream max fixed buffer 1146 displays the values for parameter akka.stream.materializer.max-fixed-buffer-size 584—the maximum size of the buffer for stream elements that have explicit buffers with a minimum of 100,000,000 and a maximum of 10,000,000,000. Stream sync processing limit 1166 displays the values for parameter akka.stream.materializer.sync-processing-limit 588—a maximum number of sync messages that actor can process for stream to substream communication, with a minimum of 100 and a maximum of 10,000. For the example of configuring and reconfiguring drone tracker parameters, these seven displays of values for the seven drone tracker framework parameters are considered dynamically with the four app parameters described relative to FIG. 4 and FIG. 10.

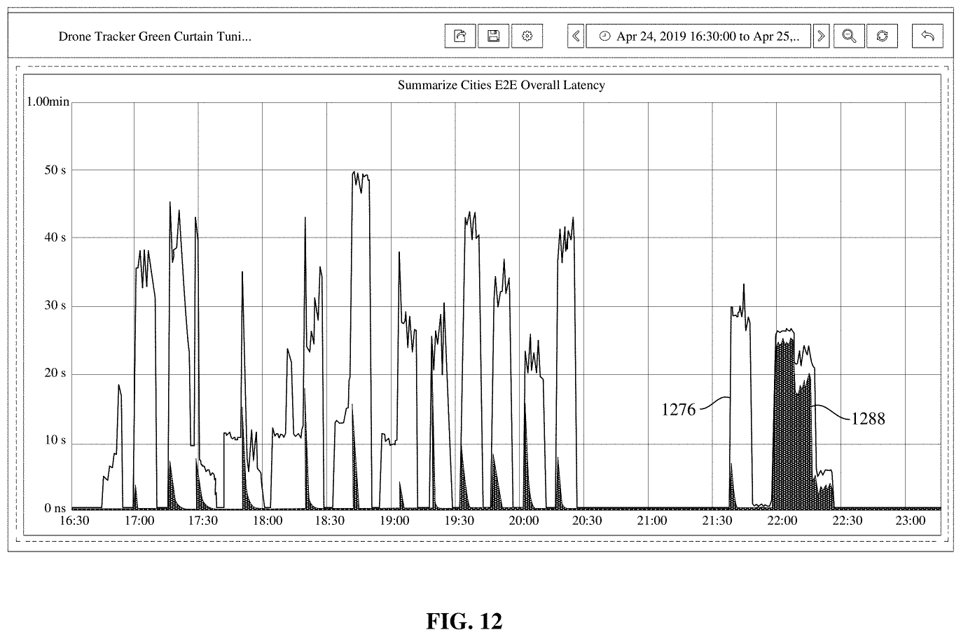

FIG. 12 displays an overall objective function, for the drone tracker example, that summarizes the end to end overall latency, as a function of time when the eleven parameters are tuned together, as described for end to end latency 344 in FIG. 3. Waveform 1276 represents the reference instance through the pipeline. Shaded waveform 1288 represents the latency as a function of time for the test stimulus through the test instance pipeline. A pause between 20:30 and 21:30 is utilized for reconfiguring the parameters for the drone track app and framework. After advancing through successive configuration points over 22 minutes, the drone tracker configuration parameters reach the test completion criteria in which the overall latency is stabilized, and the latency as a function of time for the test stimulus is lower than the latency for the reference instance through the pipeline. The test completion criteria for a descent based method are typically represented as a threshold on relative improvement. A Nelder-Mead implementation utilizes parameters for specifying stopping criteria in terms of absolute tolerance besides max iterations. Alternatively, Bayesian implementations typically use a maximum number of iterations. In one use case, an operator can request a maximum number of iterations for deciding configuration parameter configuration.

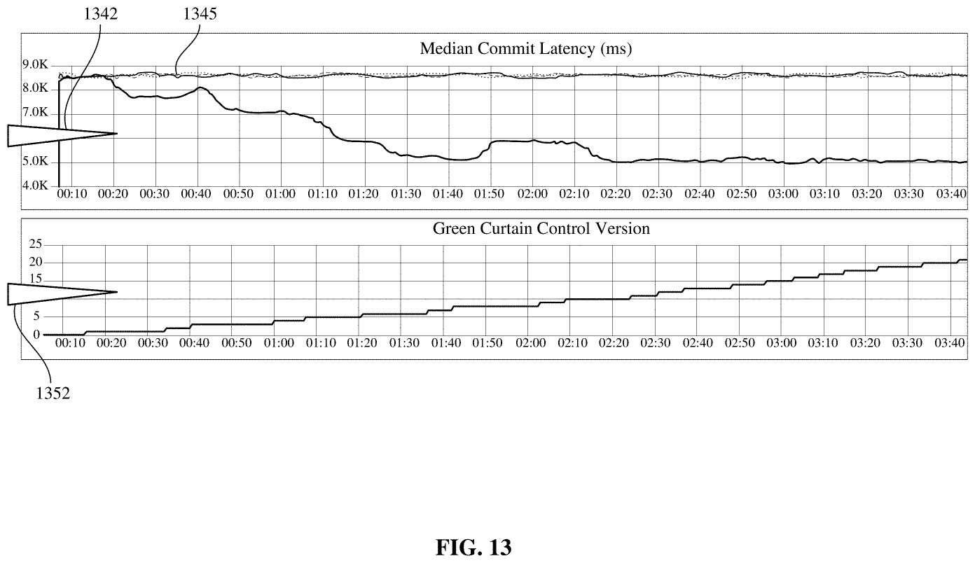

FIG. 13 shows an example of the median commit latency in milliseconds (ms) for an app that utilizes reconfiguration without restarting. During a hot reconfiguration, there is momentum. Note that no restart bars 1342 are shown in this case, because with live parameter configuration updates, no app restarts occur. The app, whose parameters are being configured, continues running as updates are applied, in this case. Note varying durations of the parameterized test, with irregular update intervals 1352 of the configuration parameters. Curve 1345 represents the baseline control app. For some apps, restarted optimization has regular and long commit latency across the iterations, and the hot reconfiguration along with LTI fit enables the shortening of the commit latency for some iterations and update intervals.

### Computer System

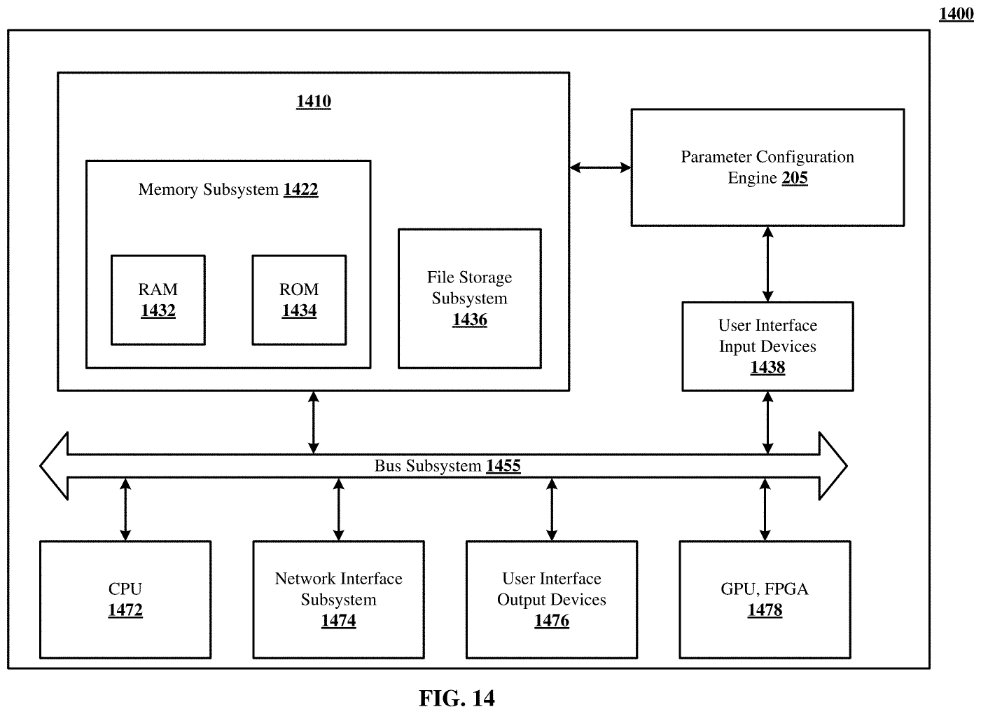

FIG. 14 is a simplified block diagram of a computer system 1400 that can be used for configuring and reconfiguring an application running on a system. Computer system 1400 includes at least one central processing unit (CPU) 1472 that communicates with a number of peripheral devices via bus subsystem 1455. These peripheral devices can include a storage subsystem 1410 including, for example, memory devices and a file storage subsystem 1436, user interface input devices 1438, user interface output devices 1476, and a network interface subsystem 1474. The input and output devices allow user interaction with computer system 1400. Network interface subsystem 1474 provides an interface to outside networks, including an interface to corresponding interface devices in other computer systems.

In one implementation, parameter configuration engine 205 of FIG. 2 is communicably linked to the storage subsystem 1410 and the user interface input devices 1438. User interface input devices 1438 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1400.

User interface output devices 1476 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1400 to the user or to another machine or computer system.

Storage subsystem 1410 stores programming and data constructs that provide the functionality of some or all of the modules and methods described herein. Subsystem 1478 can be graphics processing units (GPUs) or field-programmable gate arrays (FPGAs).

Memory subsystem 1422 used in the storage subsystem 1410 can include a number of memories including a main random access memory (RAM) 1432 for storage of instructions and data during program execution and a read only memory (ROM) 1434 in which fixed instructions are stored. A file storage subsystem 1436 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1436 in the storage subsystem 1410, or in other machines accessible by the processor.

Bus subsystem 1455 provides a mechanism for letting the various components and subsystems of computer system 1400 communicate with each other as intended. Although bus subsystem 1455 is shown schematically as a single bus, alternative implementations of the bus subsystem can use multiple busses.

Computer system 1400 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 1400 depicted in FIG. 14 is intended only as a specific example for purposes of illustrating the preferred embodiments of the present invention. Many other configurations of computer system 1400 are possible having more or less components than the computer system depicted in FIG. 14.

### PARTICULAR IMPLEMENTATIONS

Some particular implementations and features for configuring and reconfiguring an application running on a system are described in the following discussion.

In one disclosed implementation, a method for configuring and reconfiguring an application running on an application includes receiving a test configuration file that includes at least a performance evaluation criteria and upper and lower bounds of settings for configuration dimensions defining a configuration hyperrectangle. The disclosed method includes instantiating at least one reference instance of the application and one test instance of the application running on the system, wherein the reference instance and the test instance are subject to similar operating stressors during test cycles. The method also includes automatically testing alternative configurations within the configuration hyperrectangle. The automatic testing includes configuring and reconfiguring one or more components of at least the test instance of the application in the test cycles at configuration points within the configuration hyperrectangle, and applying a test stimulus to both the reference instance and the test instance of the application at the configuration points for a dynamically determined test cycle time. A particular test cycle time is dynamically determined by applying the performance evaluation criteria to the reference instance and the test instance to determine a performance difference, evaluating stabilization of the performance difference as a particular test cycle progresses, dynamically determining the particular test cycle to be complete when a stabilization criteria applied to the performance difference is met. The disclosed method further includes advancing to a next configuration point until a test completion criteria is met and reporting results of the automatic testing, including at least one set of configuration settings from one of the configuration points, selected based on the results.

The method described in this section and other sections of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this method can readily be combined with sets of base features identified as implementations.

In some implementations of the disclosed method, the system includes a container orchestration system for automating application deployment, scaling, and management of instances of the application. In one implementation this can be an open source Kubernetes container orchestration system for automating application deployment, scaling, and management. Kubernetes is usable for automating deployment, scaling, and operations of application containers across clusters of hosts and it works with a range of container tools, including Docker.

In one implementation of the disclosed method, the system includes an open-source distributed general-purpose cluster-computing framework with implicit data parallelism and fault tolerance.

Some implementations of the disclosed method also include using an operator framework to perform the configuring and reconfiguring of the components. Some implementations of the disclosed method include hot reconfiguring the reconfigured components after reconfiguration and waiting for the reconfigured components to complete reconfiguring.

For some implementations of the disclosed method, the stabilization criteria includes fitting a single pole filter curve to the performance difference as the particular test cycle progresses and evaluating a slope of the single pole filter curve to determine the test cycle time at which the performance difference has stabilized.

Some implementations of the disclosed method further include performing the automatic testing in a survey phase and search phase, wherein the survey phase includes configuration points within the configuration hyperrectangle that are selected for a survey of the configuration hyperrectangle without using results of prior test cycles; and the search phase includes configuration points selected, at least in part, using the results of the prior test cycles. For some implementations, the survey phase uses a number of configuration points, related to an integer number n of configuration dimensions, wherein the number of configuration points in the survey phase is at least n/2 and not more than 5n configuration points. For some disclosed implementations, the test configuration file further includes step sizes for at least some of the configuration dimensions and further includes using the step sizes to determine, at least in part, the configuration points to be used during the survey phase.

Some implementations of the disclosed method further include identifying in the test cycles the configuration points within the configuration hyperrectangle by fitting a regression surface with a sequence of regression fits, for example by using a Gaussian process or gradient boosted regression trees, and determining the test stimulus based on the uncertainty of the existing fit.

One implementation of the disclosed method further includes canceling a current test cycle when current settings from a current configuration point prove infeasible, as determined by unresponsiveness of a component of the test instance or a time out. Some implementations further include dynamically updating proxy evaluation values for configuration points, within the configuration hyperrectangle, to which it was infeasible to apply the performance evaluation criteria.

Some implementations of the disclosed method further include selecting configuration points within the configuration hyperrectangle to avoid initiation of test cycles at configuration points in regions of the configuration hyperrectangle that were proven, in prior test cycles, to be infeasible, as determined by unresponsiveness of a component of the test instance or a time out.

In another implementation a disclosed method for configuring and reconfiguring an application running on an application includes receiving a test configuration file that includes at least a performance evaluation criteria and upper and lower bounds of settings for configuration dimensions defining a configuration hyperrectangle. The disclosed method includes instantiating at least one reference instance of the application and one test instance of the application running on the system, wherein the reference instance and the test instance are subject to similar operating stressors during test cycles. The method also includes automatically testing alternative configurations within the configuration hyperrectangle. The automatic testing includes configuring and reconfiguring one or more components of at least the test instance of the application in the test cycles at configuration points within the configuration hyperrectangle, and starting the configured components and restarting the reconfigured components and waiting until the started and restarted components are running. The automatic testing also includes applying a test stimulus to both the reference instance and the test instance of the application at the configuration points for a dynamically determined test cycle time. The disclosed method further includes advancing to a next configuration point until a test completion criteria is met and reporting results of the automatic testing, including at least one set of configuration settings from one of the configuration points, selected based on the results.

Other implementations of the disclosed technology described in this section can include a tangible non-transitory computer readable storage media, including program instructions loaded with program instructions that, when executed on processors, cause the processors to perform any of the methods described above. Yet another implementation of the disclosed technology described in this section can include a system including memory and one or more processors operable to execute computer instructions, stored in the memory, to perform any of the methods described above.

The preceding description is presented to enable the making and use of the technology disclosed. Various modifications to the disclosed implementations will be apparent, and the general principles defined herein may be applied to other implementations and applications without departing from the spirit and scope of the technology disclosed. Thus, the technology disclosed is not intended to be limited to the implementations shown, but is to be accorded the widest scope consistent with the principles and features disclosed herein. The scope of the technology disclosed is defined by the appended claims.

What is claimed is:

1. A tangible non-transitory computer readable storage media, loaded with program instructions that, when executed on processors cause the processors to implement a method of configuring and reconfiguring an application running on a system, the method including:
receiving a test configuration file that includes at least a performance evaluation criteria and upper and lower bounds of settings for configuration dimensions defining a configuration hyperrectangle;
instantiating at least one reference instance of the application and one test instance of the application running on the system, wherein the reference instance and the test instance are subject to similar operating stressors during test cycles;
automatically testing alternative configurations within the configuration hyperrectangle, the automatic testing including:
configuring and reconfiguring one or more components of at least the test instance of the application in the test cycles at configuration points within the configuration hyperrectangle;
applying a test stimulus to both the reference instance and the test instance of the application at the configuration points for a dynamically determined test cycle time;
wherein a particular test cycle time is dynamically determined by applying the performance evaluation criteria to the reference instance and the test instance to determine a performance difference, evaluating stabilization of the performance difference as a particular test cycle progresses, dynamically determining the particular test cycle to be complete when a stabilization criteria applied to the performance difference is met; and
advancing to a next configuration point until a test completion criteria is met; and
reporting results of the automatic testing, including at least one set of configuration settings from one of the configuration points, selected based on the results.

2. The tangible non-transitory computer readable storage media of claim 1, wherein the system includes a container orchestration system for automating application deployment, scaling, and management of instances of the application.

3. The tangible non-transitory computer readable storage media of claim 2, further including using an operator framework to perform the configuring and reconfiguring of the components.

4. The tangible non-transitory computer readable storage media of claim 2, further including hot reconfiguring the reconfigured components after reconfiguration and waiting for the reconfigured components to complete reconfiguring.

5. The tangible non-transitory computer readable storage media of claim 1, wherein the system includes an open-source distributed general-purpose cluster-computing framework with implicit data parallelism and fault tolerance.

6. The tangible non-transitory computer readable storage media of claim 1, wherein the stabilization criteria includes fitting a single pole filter curve to the performance difference as the particular test cycle progresses and evaluating a slope of the single pole filter curve to determine the test cycle time at which the performance difference has stabilized.

7. The tangible non-transitory computer readable storage media of claim 1, further including performing the automatic testing in a survey phase and search phase, wherein:
the survey phase includes configuration points within the configuration hyperrectangle that are selected for a survey of the configuration hyperrectangle without using results of prior test cycles; and
the search phase includes configuration points selected, at least in part, using the results of the prior test cycles.

8. The tangible non-transitory computer readable storage media of claim 7, wherein the survey phase uses a number of configuration points, related to an integer number n of configuration dimensions, wherein the number of configuration points in the survey phase is at least n/2 and not more than 5n configuration points.

9. The tangible non-transitory computer readable storage media of claim 7, wherein the test configuration file further includes step sizes for at least some of the configuration dimensions; and
further including using the step sizes to determine, at least in part, the configuration points to be used during the survey phase.

10. The tangible non-transitory computer readable storage media of claim 1, further including identifying in the test cycles the configuration points within the configuration hyperrectangle by fitting a regression surface with a sequence of regression fits, using a Gaussian process or gradient boosted regression trees, and determining the test stimulus based on uncertainty of an existing fit.

11. The tangible non-transitory computer readable storage media of claim 1, further including canceling a current test cycle when current settings from a current configuration point prove infeasible, as determined by unresponsiveness of a component of the test instance or a time out.

12. The tangible non-transitory computer readable storage media of claim 1, further including selecting configuration points within the configuration hyperrectangle to avoid initiation of test cycles at configuration points in regions of the configuration hyperrectangle that were proven, in prior test cycles, to be infeasible, as determined by unresponsiveness of a component of the test instance or a time out.

13. The tangible non-transitory computer readable storage media of claim 12, further including dynamically updating proxy evaluation values for configuration points, within the configuration hyperrectangle, to which it was infeasible to apply the performance evaluation criteria.

14. A tangible non-transitory computer readable storage media, including program instructions loaded with program instructions that, when executed on processors cause the processors to implement a method of configuring and reconfiguring an application running on a system, the method including:
receiving a test configuration file that includes at least a performance evaluation criteria and upper and lower bounds of settings for configuration dimensions defining a configuration hyperrectangle;
instantiating at least one reference instance of the application and one test instance of the application running on the system, wherein the reference instance and the test instance are subject to similar operating stressors during test cycles;
automatically testing alternative configurations within the configuration hyperrectangle, the automatic testing including:
configuring and reconfiguring one or more components of at least the test instance of the application in the test cycles at configuration points within the configuration hyperrectangle;
starting the configured components and restarting the reconfigured components and waiting until the started and restarted components are running;
applying a test stimulus to both the reference instance and the test instance of the application at the configuration points for a test cycle time;
applying the performance evaluation criteria to the reference instance and the test instance to determine a performance difference; and
advancing to a next configuration point until a test completion criteria is met; and
reporting results of the automatic testing, including at least one set of configuration settings from one of the configuration points, selected based on the results.

15. The tangible non-transitory computer readable storage media of claim 14, wherein the system includes a container orchestration system for automating application deployment, scaling, and management of instances of the application.

16. The tangible non-transitory computer readable storage media of claim 14, further including selecting configuration points within the configuration hyperrectangle to avoid initiation of test cycles at configuration points in regions of the configuration hyperrectangle that were proven, in prior test cycles, to be infeasible, as determined by unresponsiveness of a component of the test instance or a time out.

17. The tangible non-transitory computer readable storage media of claim 16, further including dynamically updating proxy evaluation values for configuration points, within the configuration hyperrectangle, to which it was infeasible to apply the performance evaluation criteria.

18. The tangible non-transitory computer readable storage media of claim 14, further including performing the automatic testing in a survey phase and search phase, wherein:
the survey phase includes configuration points within the configuration hyperrectangle that are selected for a survey of the configuration hyperrectangle without using results of prior test cycles; and
the search phase includes configuration points selected, at least in part, using the results of the prior test cycles.

19. A method of configuring and reconfiguring an application running on a system, the method including:
receiving a test configuration file that includes at least a performance evaluation criteria and upper and lower bounds of settings for configuration dimensions defining a configuration hyperrectangle;
instantiating at least one reference instance of the application and one test instance of the application running on the system, wherein the reference instance and the test instance are subject to similar operating stressors during test cycles;
automatically testing alternative configurations within the configuration hyperrectangle, the automatic testing including:
configuring and reconfiguring one or more components of at least the test instance of the application in the test cycles at configuration points within the configuration hyperrectangle;
starting the configured components and restarting the reconfigured components and waiting until the started and restarted components are running;
applying a test stimulus to both the reference instance and the test instance of the application at the configuration points for a dynamically determined test cycle time;
advancing to a next configuration point until a test completion criteria is met; and
reporting results of the automatic testing, including at least one set of configuration settings from one of the configuration points, selected based on the results.

20. A system for configuring and reconfiguring an application running on a system, the system including a processor, memory coupled to the processor and computer instructions from the non-transitory computer readable storage media of claim 1 loaded into the memory.

21. A system for configuring and reconfiguring an application running on a system, the system including a processor, memory coupled to the processor and computer instructions from the non-transitory computer readable storage media of claim 14 loaded into the memory.

22. A method of configuring and reconfiguring an application running on a system, the method including:
receiving a test configuration file that includes at least a performance evaluation criteria and upper and lower bounds of settings for configuration dimensions defining a configuration hyperrectangle;
instantiating at least one reference instance of the application and one test instance of the application running on the system, wherein the reference instance and the test instance are subject to similar operating stressors during test cycles;
automatically testing alternative configurations within the configuration hyperrectangle, the automatic testing including:
configuring and reconfiguring one or more components of at least the test instance of the application in the test cycles at configuration points within the configuration hyperrectangle;
applying a test stimulus to both the reference instance and the test instance of the application at the configuration points for a dynamically determined test cycle time;
wherein a particular test cycle time is dynamically determined by applying the performance evaluation criteria to the reference instance and the test instance to determine a performance difference, evaluating stabilization of the performance difference as a particular test cycle progresses, dynamically determining the particular test cycle to be complete when a stabilization criteria applied to the performance difference is met; and
advancing to a next configuration point until a test completion criteria is met; and
reporting results of the automatic testing, including at least one set of configuration settings from one of the configuration points, selected based on the results.
